(19) United States
(12) Patent Application Publication
(10) Pub. No.: US 2025/0136296 A1
(43) Pub. Date: May 1, 2025

(54) PROPULSION STAGE OF A LAUNCH ROCKET, LAUNCH ROCKET AND METHOD FOR CONTROLLING A PROPULSION STAGE

(71) Applicant: Sascha Larch, Neusaess (DE)

(72) Inventor: Sascha Larch, Neusaess (DE)

(21) Appl. No.: 18/942,669

(22) Filed: Nov. 9, 2024

Related U.S. Application Data
(63) Continuation of application No. PCT/EP2023/062154, filed on May 8, 2023.

(30) Foreign Application Priority Data
May 9, 2022 (DE) DE102022111501.1

(51) Int. Cl. B64G 1/00; B64G 1/40

(52) U.S. Cl. CPC B64G 1/006; B64G 1/40

(57) ABSTRACT

A propulsion stage, in particular a reusable propulsion stage, comprising: a rocket body having a longitudinal axis; at least one recoil propulsion unit acting substantially parallel to the longitudinal axis; a plurality of rotor assemblies, each drivable by an electric rotor drive including at least one electric motor electrically connected to at least one current storage device configured to supply electrical energy to the at least one electric motor, wherein the at least one current storage device is displaceable within the propulsion stage in a direction located in a plane oriented at a right angle relative to the longitudinal axis or which has a dominant directional component which extends in the radial direction at a right angle relative to the longitudinal axis.

### RELATED APPLICATIONS

This application is a continuation of international patent application PCT/EP2023/062154 filed on May 8, 2023 claiming priority from German patent application DE 10 2022 111 501.1 filed on May 9, 2022, both of which are incorporated in their entirety by this reference.

### FIELD OF THE INVENTION

The present invention relates to a propulsion stage of a launch rocket according to the pre-characterizing portion of claim 1. In particular, the invention relates to a reusable propulsion stage. Furthermore, the invention relates to a launch rocket with at least one such propulsion stage. Finally, the invention is also directed to a method for controlling such a propulsion stage, which is used in particular during a free fall of the propulsion stage.

### BACKGROUND OF THE INVENTION

Launch rockets intended for flight into space usually have a multi-stage design, whereby a first propulsion stage equipped with recoil propulsion units propels the launch rocket into the upper regions of the troposphere up to the upper region of the stratosphere or even beyond, at an altitude of around 50 to 70 km, where a second propulsion stage is then ignited to transport the launch rocket into orbit or onto an interplanetary trajectory. The first propulsion stage falls back to earth after the engines have terminated burning and the second propulsion stage usually burns up on re-entry into the atmosphere.

For some years now, successful attempts have been made to land first stages equipped with recoil propulsion units in a controlled manner after firing so that they can be reused. Such reuse of rocket stages is desirable for economic reasons. The reusable rocket stages known to date land with the aid of controlled operation of their rocket motors and must be brought into a suitable position for a sufficient braking effect of these recoil propulsion units intended for the rocket launch when falling back to earth, which requires the provision of additional control nozzles. In addition, fuel reserves must still be available for the planned landing when falling back to earth (and possibly even when re-entering the earth's atmosphere).

WO 2020/094 640 A1 describes a two-stage launch rocket for space flight which, in addition to a recoil propulsion unit along the side of a cylindrical fuselage of the first stage, is equipped with electric duct blowers whose duct and rotation axis extends orthogonally to the longitudinal axis of the launch rocket. These blowers can act as generators when the stage falls back to earth and recharge the batteries for the blower motors. The blowers are used to ensure a controlled landing of the returned stage.

The provision of electric fans and the associated fan motors in addition to a recoil propulsion unit increases the mass to be transported into space or into higher atmospheric layers and thus reduces the payload of the launch rocket. There is no provision for controlling the first stage as it falls back to earth; the first stage only becomes controllable again at the start of the landing phase, i.e. when the fan motors are activated for the approach and landing in order to generate lift.

DE 10 2014 010 109 A1 shows and describes a rocket with a central recoil propulsion unit provided in a cylindrical rocket body and four electric propeller drives arranged around the rocket body. An electrical energy storage device inside the cylindrical rocket body is designed to be displaceable along the axis of the rocket body in order to be able to shift the center of mass of the rocket along the axis.

WO 2017/021 758 A1 shows and describes a multicopter-like carrier aircraft with electrically driven rotors for a rocket, which is designed to bring the rocket to a height of several kilometers in the atmosphere by means of the rotors of the carrier aircraft, from which the rocket is then launched. The electrical energy for the rotors is supplied from outside the carrier aircraft via lines from the ground or from escort aircraft.

### BRIEF SUMMARY OF THE INVENTION

The object of the present invention is to provide a generic propulsion stage for a launch rocket and a launch rocket equipped therewith, which is mass-optimized and which can be controlled during its return fall to earth before reaching the landing phase. In addition, it is an object of the invention to provide a method for controlling such a propulsion stage.

The part of the problem directed to the propulsion stage is solved by a propulsion stage with the features of patent claim 1.

A propulsion stage of a launch rocket, in particular a reusable propulsion stage, with a rocket body having a longitudinal axis, wherein the propulsion stage is provided with at least one recoil propulsion unit which acts predominantly parallel to the longitudinal axis and wherein the propulsion stage has a plurality of rotor assemblies which can each be driven by an electric rotor drive which has at least one electric motor, which is electrically conductively connected to at least one current storage device for supplying electrical energy, and wherein the at least one current storage device can be displaced within the propulsion stage, is characterized according to the invention in that the at least one current storage device can be moved for the purpose of displacement in a direction which lies in a plane right angled to the longitudinal axis or which has a dominant directional component which extends in the radial direction right angled to the longitudinal axis.

A recoil propulsion unit is understood here to mean a generally known assembly consisting of a combustion chamber and a rigid or pivotable thrust nozzle, and a rotor assembly is understood to mean an atmospheric propeller with propellers or rotor blades that can be driven by a rotor drive. The power storage device can have accumulators and/or capacitors, for example so-called supercapacitors, but it can also have at least one fuel cell for generating electrical energy.

The actively displaceable arrangement of the at least one current storage device inside the propulsion stage relative to the longitudinal axis makes it possible to shift the center of mass of the propulsion stage during flight, in particular during the inherently passive fall of the propulsion stage back to earth, by actively displacing the current storage device and thereby changing the flight attitude of the propulsion stage in space. Such a change in flight attitude, i.e. a change in the position and orientation of the propulsion stage in a three-dimensional space, by actively shifting the center of mass in accordance with the invention causes a change in the flight path of the propulsion stage via the resulting change in the aerodynamic airflow onto the propulsion stage. The propulsion stage can therefore be steered in flight, in particular during re-entry into the atmosphere and when falling back through the atmosphere without being influenced by steering nozzles or aerodynamic steering elements, by actively changing the position of the mass of the at least one current storage device, i.e. by actively shifting the center of mass.

Further advantageous and advantageous design features of the propulsion stage according to the invention are the subject of subclaims 2 to 8.

The direction of movement of the current storage device advantageously has a dominant directional component that extends in a radial direction at right angles to the longitudinal axis. The direction of movement can also lie in a plane that is right angled to the longitudinal axis.

Advantageously, the at least one current storage device can be moved in a direction that extends at an angle of between 90° and 60°, advantageously between 90° and 75°, to the longitudinal axis.

It is particularly advantageous if the at least one current storage device can be moved on a rail array.

Advantageously, at least one drive device is provided for moving the at least one current storage device.

It is particularly advantageous if the at least one drive device, which is comprised as an electric motor or has an electric motor, is electrically conductively connected to a control or regulating device for the movement of the at least one current storage device.

In an advantageous advanced development of the propulsion stage, the control and regulation device is part of a flight attitude control device of the propulsion stage and/or the launch rocket. This makes it possible, in particular during the return to earth, to control or regulate the flight attitude of the propulsion stage by means of a displacement of the at least one current storage device within the propulsion stage and thus by means of a displacement of the center of mass of the propulsion stage. Such a shift in the center of mass can also be used to a small extent as part of the control system during the ascent of the launch rocket.

In an advantageous embodiment of the invention, which can be combined with other embodiments, the rail arrays each run radially to the longitudinal axis. This variant is particularly advantageous if the propulsion stage has several power storage devices.

Alternatively, the at least one rail array forms a ring around the longitudinal axis, which is particularly advantageous if only one or two current storage device(s) is/are provided. Advantageously, several, for example two, ring-shaped rail arrays can also be provided, advantageously concentrically around the longitudinal axis, whose respective current storage devices can be moved in the same or opposite direction on the respective associated ring-shaped rail array.

The part of the object directed to the launch rocket is solved by a launch rocket with at least one propulsion stage according to the invention. This means that the launch rocket as a whole can also be controlled with the aid of the center of mass displacement in the propulsion stage.

To solve the part of the problem relating to the method, a method for controlling a propulsion stage is provided, which is used in particular during a free fall of the propulsion stage, and which is characterized in that the position of the center of mass of the propulsion stage is modified by displacing at least one current storage device, as a result of which the flight position of the propulsion stage in a tree-dimensional space and thus the flight path changes. Thus, during the flight of the propulsion stage or during the free fall of the propulsion stage, a controlled displacement of at least one of the current storage devices is carried out by means of the associated control and regulation device (flight position control) in order to shift the center of mass of the propulsion stage, whereupon the position and possibly also the inclination of the propulsion stage in the three-dimensional space changes. This in turn changes the course of the air flow around the propulsion stage, which deflects the trajectory of the propulsion stage.

Advantageous embodiments of the invention with additional embodiment details and further advantages are described and explained in more detail below with reference to the accompanying drawings.

### BRIEF DESCRIPTION OF THE DRAWINGS

FIG. 1 shows a vertical section through a first embodiment of a propulsion stage according to the invention along line I-I in FIG. 2 and

FIG. 2 shows a horizontal section through the propulsion stage designed according to the invention along line II-II in FIG. 1.

### DETAILED DESCRIPTION

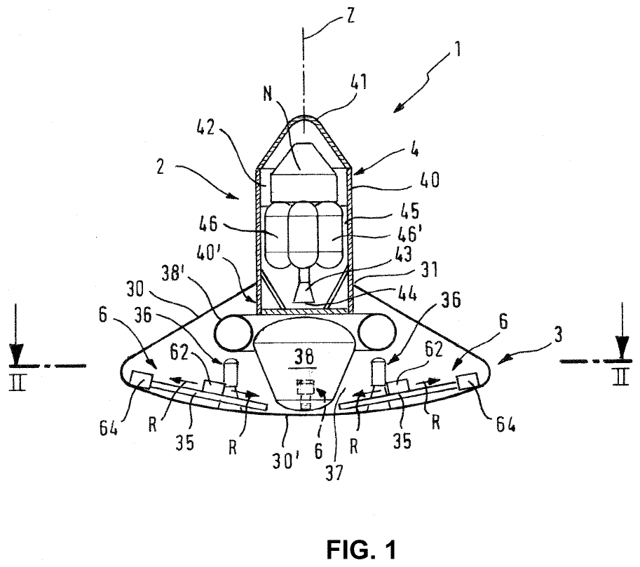

FIG. 1 shows a vertical section through a launch rocket 1 with a rocket body 2, which has a propulsion stage 3 and an upper stage 4.

The upper stage 4 essentially consists of a cylindrical housing shell 40, which is provided with a fold-down or fold-up hinged conical upper tip 41. A payload compartment 42 for accommodating a payload N is formed in the upper area of the upper stage 4, which is accessible by folding up the conical tip 41, so that the payload N can be dropped out of the payload compartment 42 in space.

In the lower region of the upper stage 4, i.e. on the underside facing away from the conical tip 41, a recoil propulsion unit 43 is provided, the outlet nozzle 44 of which is directed downwards and arranged coaxially to the vertical longitudinal axis Z of the launch rocket 1. A supply space 45 is provided between the recoil propulsion unit 43 and the payload compartment 42, in which a plurality of propellant tanks 46, 46′ are arranged, which contain the propellants for the operation of the recoil propulsion unit 43 of the upper stage and which are connected to the recoil propulsion unit 43 of the upper stage via corresponding fuel lines (not shown).

The lower area 40′ of the cylindrical housing shell 40 of the upper stage 4 facing away from the conical tip 41 engages in an adapted cylindrical receiving opening 31 in the upper side of the housing shell 30 of the propulsion stage 3 and is detachably inserted there. The upper stage 4 is connected to the propulsion stage 3 in this way so that it can be decoupled.

The housing shell 30 of the propulsion stage 3 has a spherical sector shape with a convex lower wall 30′ facing away from the upper stage 4. The reusable first rocket stage of the launch rocket 1 formed by the propulsion stage 3 has the shape of a flat truncated cone with a convex base, similar to an Apollo capsule. The outer diameter of the propulsion stage 3 is significantly larger than the outer diameter of the cylindrical upper stage 4. In the example shown, the outer diameter of the propulsion stage 3 is approximately four times as large as the outer diameter of the upper stage 4.

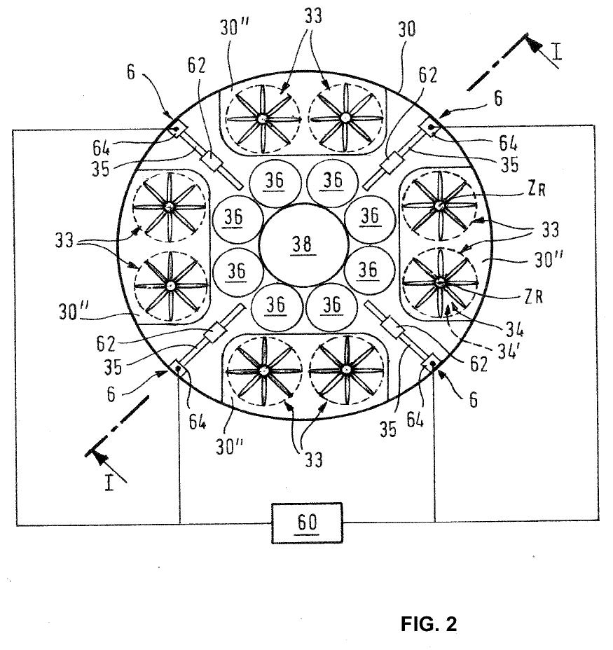

In its radially outer area, near the largest circumferential edge of the housing shell 30 of the propulsion stage 3, a plurality of rotor assemblies 33 (FIG. 2) are provided, spaced apart from one another in the circumferential direction parallel to the longitudinal axis Z of the launch rocket 1, with their respective rotor axis Z_{R} running parallel to the longitudinal axis Z of the launch rocket 1. The rotor assemblies 33 are located inside the housing shell 30 and are covered by housing sections 30″ of the housing shell 30, which can each be moved radially outwards for operation of the associated rotor assembly 33 and thus open up an air duct between themselves and the remaining central part of the housing shell 30, which air duct extends essentially parallel to the longitudinal axis Z and in which at least one rotor assembly is located, respectively. In the example shown in FIG. 2, a pair of such rotor assemblies is located in a parallel-axis air duct formed in this way, wherein four radially outwardly movable housing sections 30″ are provided distributed around the circumference at an angle of 90° to each other.

Alternatively, the housing shell 30 can have several vertically extending air ducts distributed around the circumference of the propulsion stage 3, in each of which a rotor assembly 33 is arranged. The upper openings and the lower openings of the air ducts can be closed in the area of the housing shell 30 by means of protective flaps.

Advantageously, eight propeller-like rotor assemblies 33 are provided, each of which can be driven electrically by a rotor drive with a motor comprised of an electric motor (FIG. 2). Each of these rotor assemblies 33 has an upper rotor 34 and a lower rotor 34′ which, in an operating state driven by the motor, can be driven in the same direction or in opposite directions (depending on the type of the respective propeller-like rotor 34, 34′) to generate a vertical air flow-in the upward direction or in the downward direction.

A plurality of recoil propulsion units 36 is provided radially inside of the rotor assemblies 33 in a respective engine compartment, with one recoil propulsion unit 36 being assigned to each rotor assembly 33. The outlet nozzle of the respective recoil propulsion unit 36 forming a thrust nozzle is directed away from the payload compartment 42 and opens downwards. The engine compartment, which is open downwards during operation of the recoil propulsion units 36, can be closed in each case by at least one protective flap (not shown). These protective flaps close off the respective engine compartment, particularly during a dive flight of the reusable propulsion stage 3 back to earth.

A central fuel tank 38 for storing a fuel and an annular fuel tank 38′ for storing an oxidizer for supplying the recoil propulsion units 36 are arranged in a central interior region 37 radially inside and above the engine compartments.

A power supply unit 6 is provided substantially radially outside the recoil propulsion units 36 between the pairs of rotor assemblies 33 adjacent to one another in the circumferential direction in those regions of the propulsion stage 3 which lie between two housing sections 30″ which are adjacent in the circumferential direction and can be moved radially outwards. The respective power supply unit 6 has a rail array 35 extending in the radial direction and inclined to the longitudinal axis Z, on at least one rail of which a movable current storage device 62 is provided so that it can be displaced. In the example shown, four power supply units 6 are provided with rail arrays 35 arranged at a circumferential distance of 90° from one another; however, less, or more power supply units with corresponding rail arrays and power supply devices can also be provided. The displaceability of the power storage devices 62 in the displacement direction R is symbolized by the double arrows in FIG. 1.

Each power supply unit 6 has a drive device, advantageously with an electric motor or comprised of an electric motor, as a displacement drive 64 for displacing the current storage device 62 along the associated rail array 35. The respective translation drive 64 is designed, for example, as a spindle drive known per se to the person skilled in the art and for this purpose has a drive motor and a threaded spindle driven by the latter, in which a spindle nut coupled or firmly connected to the associated current storage device 62 engages. Other translation drives can also be provided for moving the current storage device 62 along the associated rail array 35, for example a linear motor as a translational drive or a toothed belt drive.

The displacement drives 64 are electrically connected to a common control or regulating device 60, which controls or regulates the translational displacement of the individual current storage devices 62 and thus causes a displacement of the center of mass of the propulsion stage 3. For this purpose, the control or regulating device 60 is part of a higher-level attitude control or regulation system of the propulsion stage 3 and/or the launch rocket 1.

By displacing at least one current storage device 62 in a radial direction—as in the example in the figures—or along an annular rail array not shown in the figures, which is arranged concentrically around the longitudinal axis Z, for example between the recoil propulsion units 36 and the rotor assemblies 33, the position of the center of mass of the propulsion stage 3 is changed, whereby the flight position of the propulsion stage 3 in the three-dimensional space and thus its flight path changes.

Reference numerals in the description and the drawings are merely intended to facilitate understanding of the invention and do not limit the scope of protection which is solely defined by the appended patent claims.

### REFERENCE NUMERALS AND DESIGNATIONS

1 launch rocket
2 rocket body
3 propulsion stage
4 upper stage
6 power supply unit
30 housing shell of the propulsion stage
30′ convex lower wall
30″ housing section
31 cylindrical receiving opening
33 rotor assembly
33′ electric motor
33′A electric motor
33′B electric motor
34 upper rotor
34′ lower rotor
35 rail array
36 recoil propulsion unit
36A recoil propulsion unit
36B recoil propulsion unit
37 central interior area
38 central fuel tank
38′ ring-shaped fuel tank
40 cylindrical housing shell of the upper stage
40′ lower area of the cylindrical housing shell
41 conical upper tip
42 payload compartment
43 recoil propulsion unit of the upper stage
44 outlet nozzle
45 supply space
46 fuel tank
46′ fuel tank
60 control or regulating device
62 electric current storage device
64 displacement drive
N payload
R direction
Z longitudinal axis
Z_{R} rotor axis

What is claimed is:

1. A propulsion stage for a launch rocket, the propulsion stage comprising:
a rocket body having a longitudinal axis;
at least one recoil propulsion unit acting substantially parallel to the longitudinal axis;
a plurality of rotor assemblies, each drivable by an electric rotor drive including at least one electric motor electrically connected to at least one current storage device configured to supply electrical energy to the at least one electric motor,
wherein the at least one current storage device is displaceable within the propulsion stage in a direction located in a plane oriented at a right angle relative to the longitudinal axis or which has a dominant directional component which extends in the radial direction at a right angle relative to the longitudinal axis.

2. The propulsion stage according to claim 1, wherein the at least one current storage device is displaceable in a direction which extends at an angle between 90° and 60°, or between 90° and 75° relative to the longitudinal axis.

3. The propulsion stage according to claim 1, wherein the at least one current storage device is movable on at least one rail array.

4. The propulsion stage according to claim 3, wherein at least one drive device is configured to displace the at least one current storage device.

5. The propulsion stage according to claim 4, wherein the at least one drive device is electrically connected to a control or regulating device configured to displace the at least one current storage device.

6. The propulsion stage according to claim 5, wherein the control and regulating device is part of a flight attitude control device of the propulsion stage and/or of a launch rocket.

7. The propulsion stage according to claim 3, wherein the at least one rail array extends in a radial direction relative to the longitudinal axis.

8. The propulsion stage according to claim 3, wherein the at least one rail array forms a ring around the longitudinal axis.

9. A launch rocket, comprising: at least one propulsion stage according to claim 1.

10. A method for controlling a propulsion stage according to claim 1 during a free fall of the propulsion stage, the method comprising: modifying a position of the center of mass of the propulsion stage by displacing at least one current storage device, so that a flight attitude of the propulsion stage in a three-dimensional space and thus a flight path of the propulsion stage is modified.
